(19) United States
(12) Patent Application Publication
(10) Pub. No.: US 2011/0113216 A1
(43) Pub. Date: May 12, 2011

(54) INFORMATION PROCESSING APPARATUS

(75) Inventors: Kouichi Toita, Yokohama-shi (JP); Nobutoshi Higaki, Yokohama-shi (JP); Toshihiro Hishida, Yokohama-shi (JP)

(73) Assignee: PANASONIC CORPORATION, Kadoma-shi, Osaka (JP)

(21) Appl. No.: 12/674,669

(22) PCT Filed: Aug. 31, 2007
(86) PCT No.: PCT/JP2007/067071

§ 371 Date: Feb. 22, 2010

(51) Int. Cl. G06F 12/10; G06F 12/00

(52) U.S. Cl. 711/206; 711/E12.001; 711/E12.059

(57) ABSTRACT

An information processing apparatus includes: a ROM for storing a program therein; a RAM for temporarily storing therein the program read from the ROM; a program execution unit that is adapted to read and execute the program from the ROM or the RAM; a memory management unit that translates a virtual address output by the program execution unit to a physical address of the ROM or the RAM; a page table storage unit for storing therein a page table which is referred to by the memory management unit, and in which mapping data of a virtual address with a physical address of the ROM or the RAM corresponding to the virtual address is stored; a detection unit that detects change of an event in the information processing apparatus; an operation switching unit that is adapted to instruct, when the detection unit detects the change of the event during a ROM-operation in which the program execution unit reads the program from the ROM, switching from the ROM-operation to a RAM-operation in which the program execution unit reads the program from the RAM; and a page table updating unit that updates the page table which is referred to by the memory management unit, depending on the instruction of the operation switching unit.

### TECHNICAL FIELD

The present invention relates to an information processing apparatus and an operation switching method for switching between ROM-operation and RAM-operation.

### BACKGROUND ART

An information processing apparatus, which implements desired functions by executing programs, includes a ROM (Read Only Memory) for storing the programs therein, a RAM (Random Access Memory) for temporarily storing therein the programs read from the ROM, an MMU (Memory Management Unit) that translates a virtual address to a physical address, a page table for storing therein mapping data of virtual addresses and physical addresses corresponding to the virtual addresses, and a CPU (Central Processing Unit) that reads and executes the programs stored in the ROM or RAM with reference to the MMU. As described in Patent Literature 1, the RAM can perform higher-speed operation in comparison with the ROM. That is, a reading speed from the RAM by the CPU is higher than a reading speed from the ROM. Thus, the high-speed operation can be performed by temporarily storing data stored in the ROM into the RAM, and reading the data stored in the RAM by the CPU.

However, if programs are accumulatively stored into the RAM from the ROM, free space of the RAM decreases. Thus, if the free space of the RAM is sufficient, the CPU performs RAM-operation to read the program from the RAM; whereas if the free space of the RAM is run out, the CPU performs ROM-operation to read the program from the ROM.

FIG. 6 is a block diagram showing an information processing apparatus for performing RAM-operation in a state where physical addresses are not set to a page table. As shown in FIG. 6, a CPU 1 refers to an MMU 3 for a physical address corresponding to a virtual address (1). Although the MMU 3 refers to a page table (2), a page fault occurs because physical addresses of a RAM 7 are not set to the page table 5. Thus, data of relevant address ranges are copied to the RAM 7 from a ROM 9 (3), and a physical address of the RAM 7, the data of which has been copied, is set to the page table 5 (4). The MMU 3 returns the physical address obtained from the page table 5 to the CPU 1 as a response to the reference of (1).

FIG. 7 is a block diagram showing an information processing apparatus for performing RAM-operation in a state where physical addresses are set to the page table. As shown in FIG. 7, the CPU 1 refers to the MMU 3 for an address corresponding to a virtual address (1). The MMU 3 refers to the page table 5 (2), and obtains the physical address of the RAM 7. The MMU 3 returns the physical address obtained from the page table 5 to the CPU 1 as a response to the reference of (1).

FIG. 8 is a block diagram showing an information processing apparatus showing how to set a physical address of ROM to the page table. As shown in FIG. 8, if there is no page table of the ROM, a page table 5 is created (1), and a relevant physical address of the ROM 9 is set to the page table 5.

FIG. 9 is a block diagram showing an information processing apparatus for performing ROM-operation in a state where physical addresses of the ROM are set to the page table. As shown in FIG. 9, the CPU 1 refers to the MMU 3 for an address corresponding to a virtual address (1). The MMU 3 refers to the page table 5 (2), and obtains the physical address of the ROM 9. The MMU 3 returns the physical address obtained from the page table 5 to the CPU 1 as a response to the reference of (1).

As described above, the information processing apparatus switches from the RAM-operation to the ROM-operation depending on the free space of the RAM. FIG. 10 is a block diagram showing an information processing apparatus for performing RAM-operation because there is a sufficient free space in RAM. As shown in FIG. 10, the CPU 1 refers to a header of the ROM 9, and obtains a data size of a program to be executed (1), and checks whether there is a free space equal to or more than the data size in the RAM (2). If there is sufficient free space in the RAM 7, data of the program to be executed are copied from the ROM 9 to the RAM 7. the CPU 1 performs the RAM-operation to read and execute the program which has been copied from the ROM 9 to the RAM 7. Later, if the free space equal to or more than data size of a program to be executed is insufficient in the RAM 7, the CPU 1 switches to the ROM-operation to read and execute the program from the ROM 9.
Patent Literature 1: JP-11-129558A

### DISCLOSURE OF INVENTION

### Problems to be Solved by Invention

As explained above, the CPU switches from the RAM-operation to the ROM-operation depending on the data size of the program to be executed and the free space of the RAM. Since the space of the RAM is limited, when many programs are executed or a program having a large data size is executed on the information processing apparatus, the free space of the RAM becomes insufficient, thus the apparatus shifts to the ROM-operation. The reading speed of the CPU in the ROM-operation is lower in comparison with that in the RAM-operation. Thus, the execution speed of the program lowers in comparison with that in RAM-operation. Therefore, the program cannot be executed speedily in a state where free space is insufficient in the RAM. Although the free space of the RAM 7 can be secured if the data stored in the RAM 7 discarded, it becomes required to perform a process to discard the data. Thus, it is impossible to increase the program execution speed in this case.

An object of the present invention is to provide an information processing apparatus and an operation switching method which can arbitrarily increase the execution speed of the program depending on the situation.

Means For Solving Problems

The present invention provides an information processing apparatus including: a ROM for storing a program therein; a RAM for temporarily storing therein the program read from the ROM; a program execution unit that is adapted to read the program from the ROM or the RAM and execute the read program; a memory management unit that is adapted to translate a virtual address output by the program execution unit to a physical address of the ROM or the RAM before the program execution unit reads the program from the ROM or the RAM; a page table storage unit for storing therein a page table which is referred to by the memory management unit, and in which mapping data of a virtual address with a physical address of at least either of the ROM and the RAM corresponding to the virtual address is stored; a detection unit that is adapted to detect change of an event in the information processing apparatus; an operation switching unit that is adapted to instruct, when the detection unit detects the change of the event during a ROM-operation in which the program execution unit reads the program from the ROM, switching from the ROM-operation to a RAM-operation in which the program execution unit reads the program from the RAM; and a page table updating unit that is adapted to update the page table which is referred to by the memory management unit, depending on the instruction of the operation switching unit.

The information processing apparatus includes a space detection unit that is adapted to detect a free space of the RAM, and the operation switching unit instructs switching from the ROM-operation to the RAM-operation if there is a predetermined space in the RAM when the detection unit detects the change of the event or initiation of the specific application.

In the information processing apparatus, the page table storage unit includes: a page table for ROM in which mapping data of a virtual address with a physical address of the ROM corresponding to the virtual address is stored; and a page table for RAM in which mapping data of the virtual address with a physical address of the RAM corresponding to the virtual address is stored.

In the information processing apparatus, the change of the event indicates a change in clock speed of the program execution unit, and the operation switching unit instructs switching from the ROM-operation to the RAM-operation when the detection unit detects the change in clock speed from a low speed to a high speed.

In the information processing apparatus, the change of the event indicates an operation to the information processing apparatus, and the operation switching unit instructs switching from the ROM-operation to the RAM-operation when the detection unit detects the operation to the information processing apparatus.

In the information processing apparatus, the change of the event indicates an occurrence of irregular interruption process other than regularly-occurred process, and the operation switching unit instructs switching from the ROM-operation to the RAM-operation when the detection unit detects the occurrence of the irregular interruption process.

In the information processing apparatus, the change of the event indicates an initiation of a specific application, and the operation switching unit instructs switching from the ROM-operation to the RAM-operation when the specific application is initiated.

The present invention provides an operation switching method performed by an information processing apparatus that includes: a ROM for storing a program therein; a RAM for temporarily storing therein the program read from the ROM; a program execution unit that is adapted to read the program from the ROM or the RAM and execute the read program; a memory management unit that is adapted to translate a virtual address output by the program execution unit to a physical address of the ROM or the RAM before the program execution unit reads the program from the ROM or the RAM; and a page table storage unit for storing therein a page table which is referred to by the memory management unit, and in which mapping data of a virtual address with a physical address of at least either of the ROM and the RAM corresponding to the virtual address is stored, wherein the operation switching method includes: detecting change of an event in the information processing apparatus; instructing, when the change of the event is detected during a ROM-operation in which the program execution unit reads the program from the ROM, switching from the ROM-operation to a RAM-operation in which the program execution unit reads the program from the RAM; and updating the page table which is referred to by the memory management unit, depending on the instruction.

### Advantageous Effect of Invention

In accordance with the information processing apparatus and the operation switching method according to the present invention, it is possible to efficiently utilize the RAM and increase the execution speed of the program depending on the situation.

### BRIEF DESCRIPTION OF DRAWINGS

FIG. 1 is a block diagram showing an information processing apparatus according to a first embodiment.

FIG. 2 is a flowchart showing switching process performed by the information processing apparatus according to the first embodiment.

FIG. 3 is a flowchart showing the switching process depending on occurrence of an event.

FIG. 4 is a block diagram showing an information processing apparatus according to a second embodiment.

FIG. 5 is a flowchart showing switching process depending on initiation of a specific application.

FIG. 6 is a block diagram showing an information processing apparatus for performing RAM-operation in a state where physical addresses are not set to a page table.

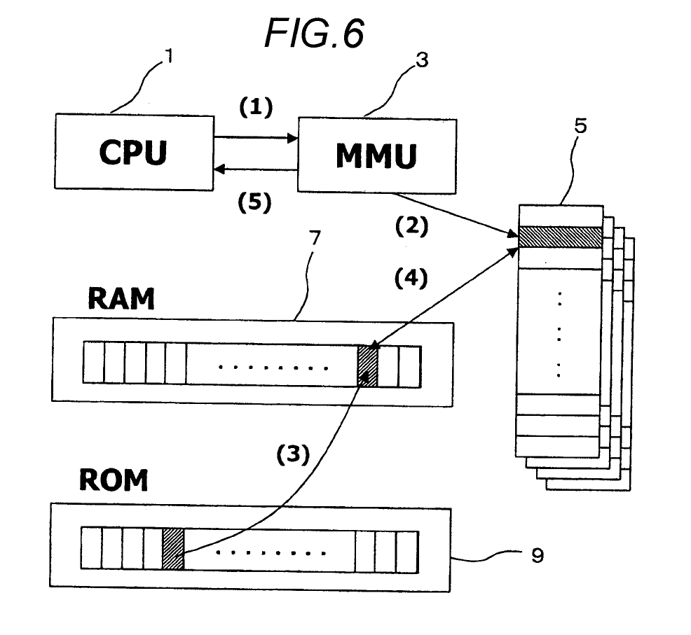

FIG. 7 is a block diagram showing an information processing apparatus for performing RAM-operation in a state where physical addresses are set to the page table.

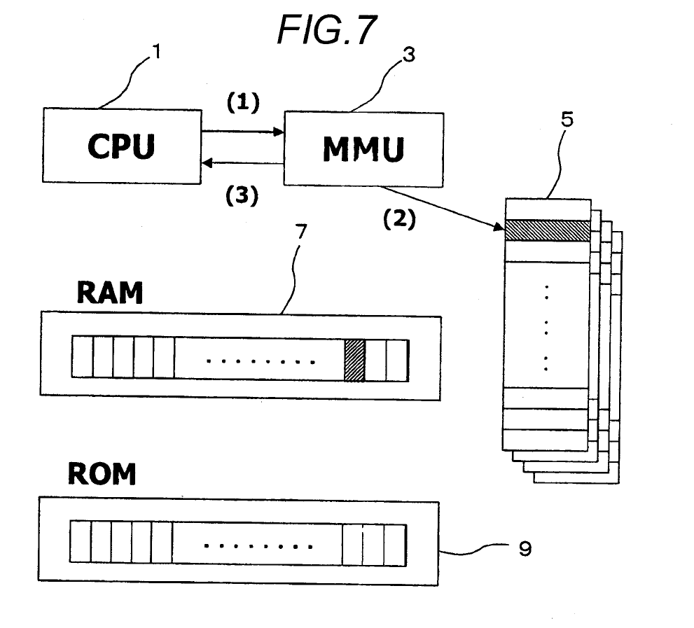

FIG. 8 is a block diagram showing an information processing apparatus showing how to set a physical address of ROM to the page table.

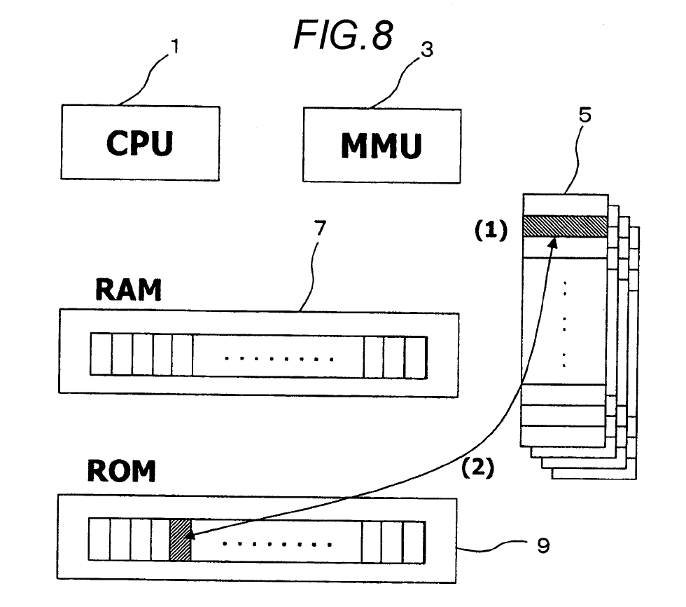

FIG. 9 is a block diagram showing an information processing apparatus for performing ROM-operation in a state where physical addresses of the ROM are set to the page table.

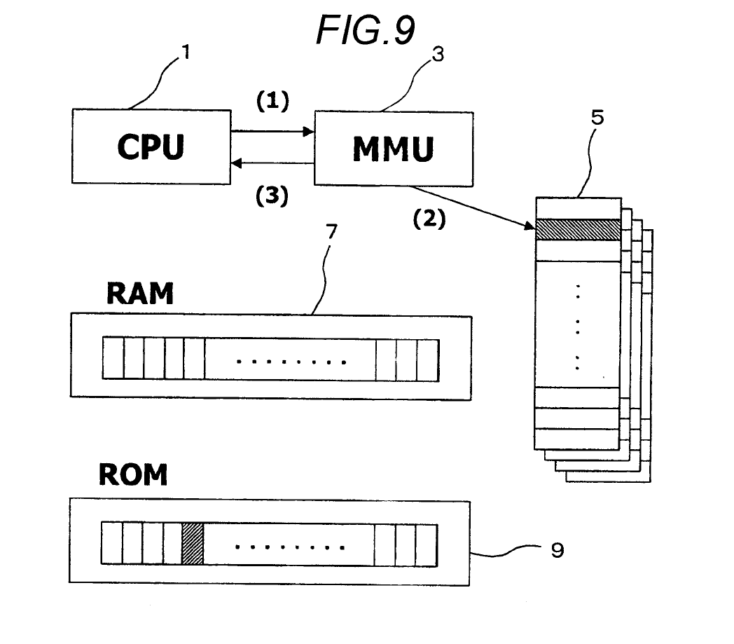

FIG. 10 is a block diagram showing an information processing apparatus for performing RAM-operation because there is a sufficient free space in RAM.

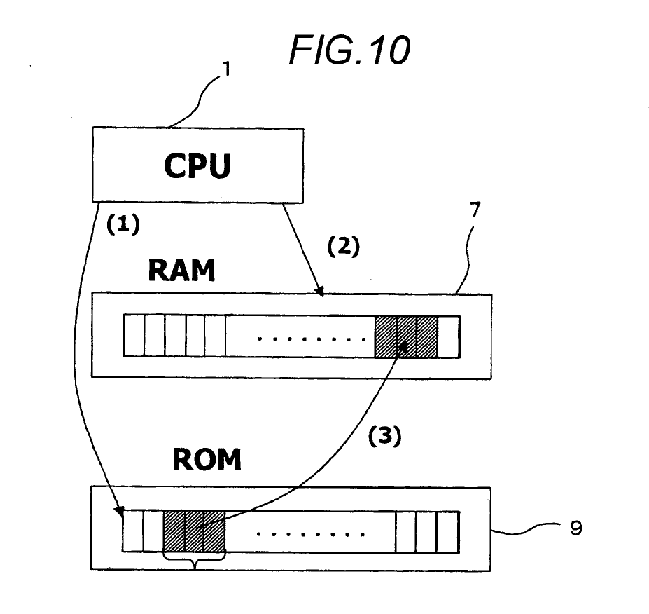

### DESCRIPTION OF REFERENCE NUMERALS AND SIGNS

101 CPU
103 ROM
105 RAM
107 MMU (Memory Management Unit)
109 Page Management Unit
111 Event Detection Unit
113 Status Determination Unit
115, 215 Operation Switching Unit
151 Page Table
153 Page Table For ROM
155 Page Table For RAM
157 Page Fault Processing Unit
159 Page Table Updating Unit
211 Initiation Processing Unit
221 Storage Table Of RAM-Operated Application

### BEST MODE FOR CARRYING OUT INVENTION

Hereinafter, description will be made of embodiments of the present invention with reference to drawings.

### First Embodiment

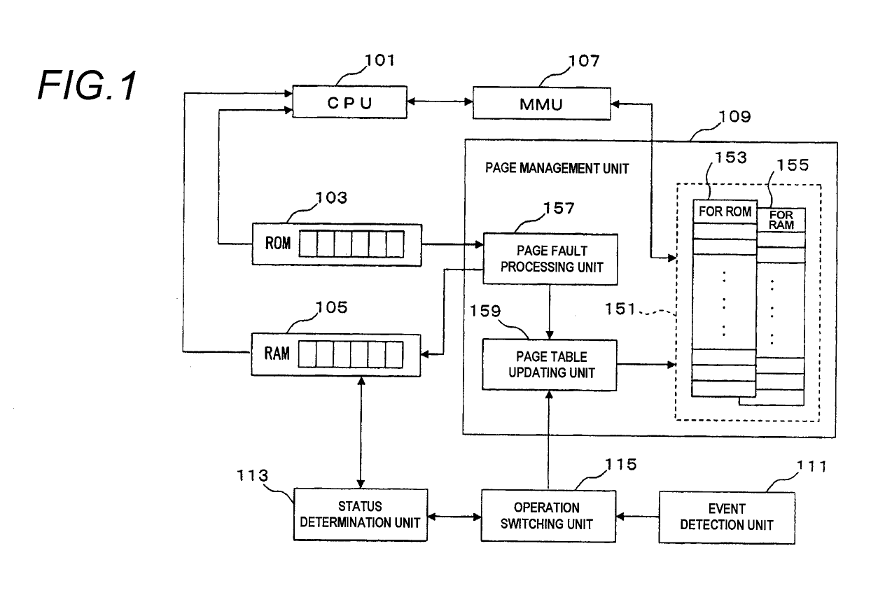

FIG. 1 is a block diagram showing an information processing apparatus according to a first embodiment. As shown in FIG. 1, the information processing apparatus according to the first embodiment includes a CPU 101, a ROM 103, a RAM 105, an MMU (Memory Management Unit) 107, a page management unit 109, an event detection unit 111, a status determination unit 113, and an operation switching unit 115.

The CPU 101 read and executes a program stored in the ROM 103 or the RAM 105 with reference to the MMU 107. The ROM 103 stores therein the program to be executed by the CPU 101. The RAM 105 temporarily stores therein the program read from the ROM 103. The MMU 107 translates a virtual address output by the CPU 101 to a physical address before the CPU 101 reads the program from the ROM 103 or the RAM 105.

The page management unit 109 includes a page table 151, a page fault processing unit 157, and a page table updating unit 159. The page table 151 stores therein mapping data of a virtual address with a corresponding physical address. The page table 151 is referred to by the MMU 107. Note that the page table 151 includes a page table for ROM 153, and a page table for RAM 155. In the page table for ROM 153, mapping data of a virtual address and a physical address of the ROM 103 is stored. On the other hand, mapping data of a virtual address and a physical address of the RAM 105 is stored in the page table for RAM 155.

The page fault processing unit 157 reads the program from the ROM 103 and write it to the RAM 105. The page table updating unit 159 updates the page table for RAM 155 when the page fault processing unit 157 writes the program from the ROM 103 into the RAM 105. Further, the page table updating unit 159 switches the page table 155 to be referred by the MMU 107 between the page table for ROM 153 and the page table for RAM 155. That is, the page table updating unit 159 sets the page table to be referred by the MMU 107 to the page table for ROM 153 when the CPU 101 performs ROM-operation for reading the program from the ROM 103; whereas the page table updating unit 159 sets the page table to be referred by the MMU 107 to the page table for RAM 155 when the CPU 101 performs RAM-operation for reading the program from the RAM 105.

The event detection unit 111 detects a change of an event. The change of the event indicates a change of a clock speed of the CPU 101, a button operation by a user using a button, not shown in figure, provided on the information processing unit, an occurrence of irregular interruption process other than regularly-occurred process, etc. The status determination unit 113 detects a free space of the RAM 105 in accordance with an instruction from the operation switching unit 115 to determine whether there is a sufficient free space in the RAM 105 which can be switched from the ROM-operation to the RAM-operation, and send a determination result to the operation switching unit.

When the event detection unit 111 detects the change of the event during the CPU 101 is in the ROM-operation, the operation switching unit 115 instructs to the page table updating unit 159 contained in the page management unit 109 to switch from the ROM-operation to the RAM-operation, depending on the determination result by the status determination unit 113. That is, the operation switching unit 115 instructs to the page table updating unit 159 to switch from the ROM-operation to the RAM-operation if it is determined by the status determination unit 113 that there is sufficient free space in the RAM 105; whereas the operation switching unit 115 does not instruct the same if it is determined by the status determination unit 113 that there is no sufficient free space in the RAM 105.

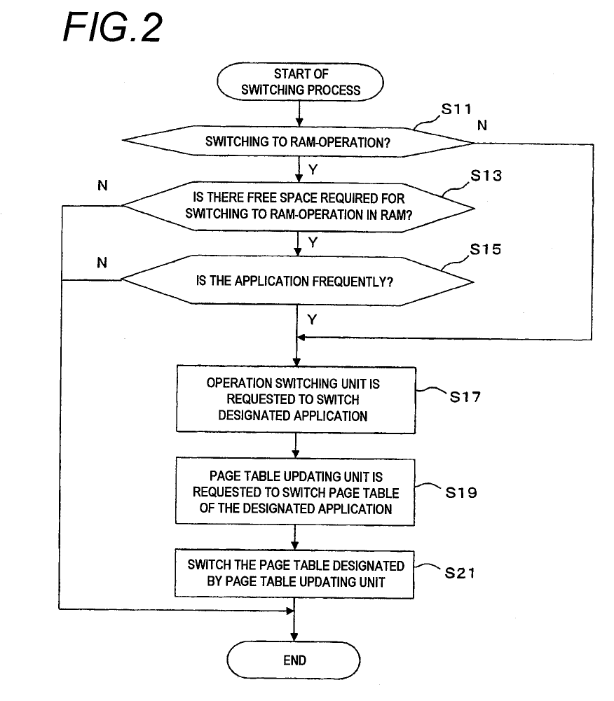

FIG. 2 is a flowchart showing switching process performed by the information processing apparatus according to the first embodiment. As shown in FIG. 2, it is determined whether to switch to the RAM-operation in a step S11. In a case where it is determined to switch to the RAM-operation, it advances to a step S13, whereas in a case where it is determined not to switch to the RAM-operation, the process advances to a step S17. In the step S13, it is determined whether there is a free space required for switching to the RAM-operation in the RAM 105, and if there is a free space, the process advances to a step S15, whereas if there is no space, the process ends. In the step S15, it is determined whether the application is used frequently, and if frequent, the process advances to the step S17; whereas if not frequent, the process ends.

In the step S17, the operation switching unit 115 is requested to switch a designated application. Next, in a step S19, the page table updating unit 159 is requested to switch a page table of the designated application. Next, in a step S21, the page table designated by the page table updating unit 159 is switched.

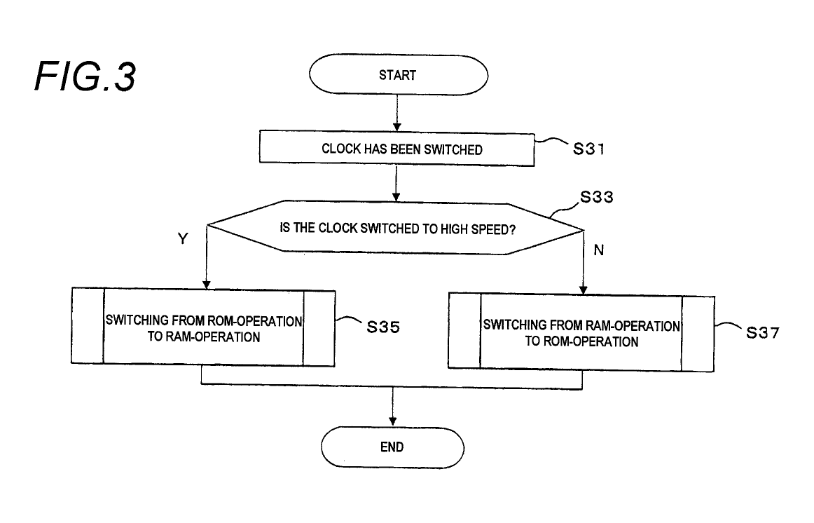

Further, FIG. 3 is a flowchart showing the switching process depending on occurrence of an event. As shown in FIG. 3, when a clock speed of the CPU 101 is switched in a step S31, it is determined whether the clock speed is switched from a low speed to a high speed in a step S33. If it is a switch to the high speed, the process advances to a step S35, whereas if it is the opposite to that (a switch to the low speed from the high speed), the process advances to a step S37. In the step S35, the operation is switched from the ROM-operation to the RAM-operation. In the step S37, the operation is switched from the RAM-operation to the ROM-operation.

As explained above, in the information processing apparatus of the present embodiment, the operation is switched from the ROM-operation to the RAM-operation if there is a sufficient free space in the RAM, depending on the occurrence of the event. Hitherto, the RAM-operation has been consistently performed if there is a free space in the RAM 105. In the present embodiment, however, “needed/unneeded” of the RAM-operation is determined depending on the situation, and the RAM-operation is performed when needed. For example, when the clock speed of the CPU 101 is changed from a low speed to a high speed, when a button operation is performed, or when a irregular interruption process occurs, the operation is switched from the ROM-operation to the RAM-operation if there is sufficient free space in the RAM 105. Further, when the clock speed of the CPU 101 is changed from a high speed to a low speed, when the button operation is not performed for a certain period of time, or when the irregular interruption process ends, the operation is switched from the RAM-operation to the ROM-operation. In this way, by switching the operation between the ROM-operation and the RAM-operation depending on the situation, it is possible to sufficiently utilize the RAM 105 and to arbitrarily increase the execution speed of the program.

### Second Embodiment

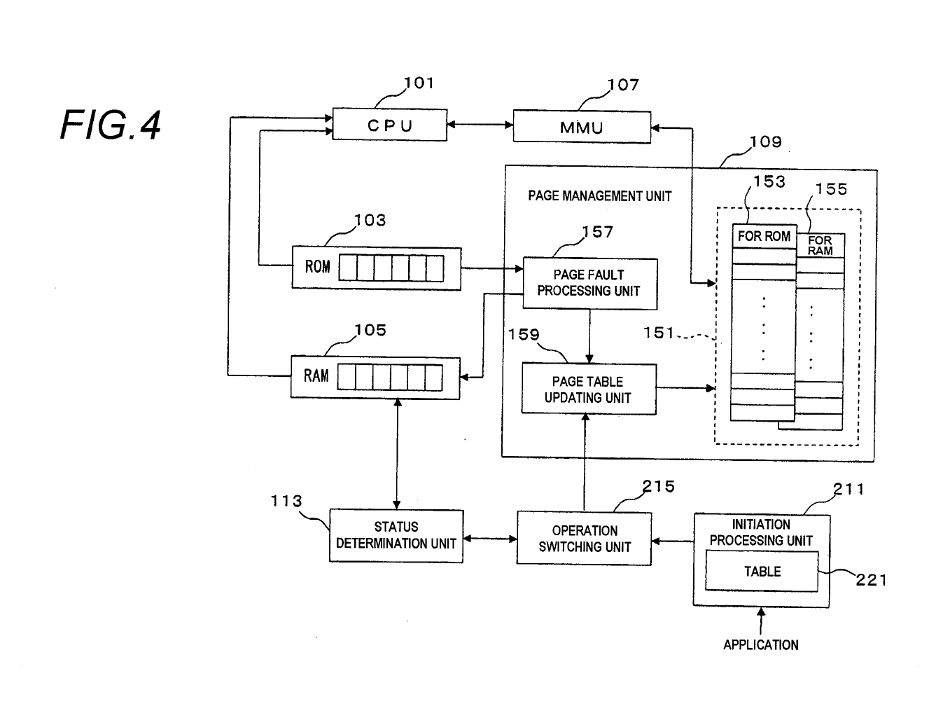

FIG. 4 is a block diagram showing an information processing apparatus according to a second embodiment. An information processing apparatus of the second embodiment includes the CPU 101, the ROM 103, the RAM 105, the MMU 107, the page management unit 109 and the status determination unit 113, which are same as those in the first embodiment, and an initiation processing unit 211 and an operation switching unit 215. Since the CPU 101, the ROM 103, the RAM 105, the MMU 107, the page management unit 109, the status determination unit 113 are the same as those in the first embodiment, explanation of these are omitted.

The initiation processing unit 211 processes initiation of an application designated by a user of the information processing apparatus. When instructed to initiate a specific application, the initiation processing unit 211 instructs to the operation switching unit 215 to switch to the ROM-operation to the RAM-operation. The initiation processing unit 211 memorizes a table 221 for setting when the above instruction is performed in a case where initiation of what application is instructed.

When received from the instruction from the initiation processing unit 211 during the CPU 101 is in the ROM-operation, the operation switching unit 215 instructs to the page table updating unit 159 contained in the page management unit 109 to switch from the ROM-operation to the RAM-operation, depending on the determination result by the status determination unit 113. That is, as in the first embodiment, the operation switching unit 115 instructs to the page table updating unit 159 to switch from the ROM-operation to the RAM-operation if it is determined by the status determination unit 113 that there is sufficient free space in the RAM 105; whereas the operation switching unit 115 does not instruct the same if it is determined by the status determination unit 113 that there is no sufficient free space in the RAM 105.

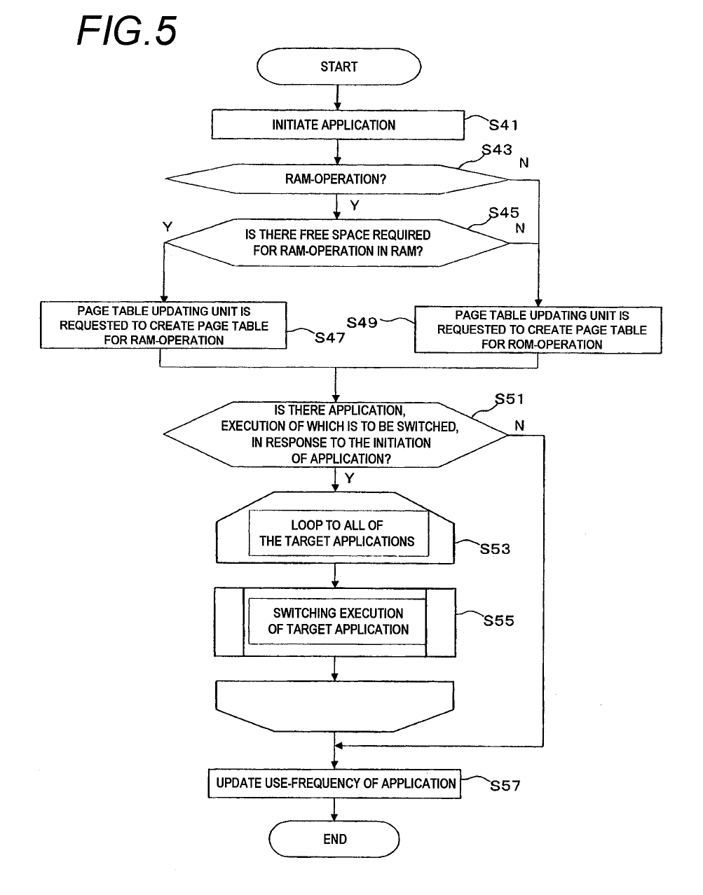

FIG. 5 is a flowchart showing switching process depending on initiation of a specific application. As shown in FIG. 5, when an application is initiated in a step S41, it is determined in a step S43 that the RAM-operation is performed. If it is to be performed, the process advances to a step S45, whereas if it is not to be performed, the process advances to a step S49. In the step S45, it is determined whether there is a free space required for switching to the RAM-operation in the RAM 105, and if there is a free space, the process advances to a step S47, whereas if there is no space, the process advances to a step S49. In the step S47, the page table updating unit 159 is requested to create a page table for the RAM-operation. In the step S49, the page table updating unit 159 is requested to create a page table for the ROM-operation.

Next, in a step S51, it is determined whether there is an application, the operation of which is to be switched, in response to the initiation of an application. If it exists, the process advances to a step S53, whereas if not, the process advances to a step S57. In the step S53, the step S55 is performed with respect to all of the target applications. In the step S55, an execution of the target application is switched. In the step S57, a use frequency of the application initiated in the step S41 is updated.

As explained above, in the information processing apparatus of the present embodiment, the operation is switched from the ROM-operation to the RAM-operation if there is a sufficient free space in the RAM 105, depending on the initiation of the specific application. When the execution of the specific application ends, the operation is switched from the RAM-operation to the ROM-operation. In this way, by switching the operation between the ROM-operation and the RAM-operation depending on the situation, it becomes possible to utilize the RAM 105 sufficiently, and to increase the execution speed of the specific application.

Note that the above specific application is changeable by the user. When the specific application to be executed in the RAM-operation is changed, the table 221 memorized by the initiation processing unit 211 is rewritten.

The initiation processing unit 211 may include a use-frequency measuring unit (not shown in figure) which measures a use-frequency for each application. In this case, the initiation processing unit 211 may determine the specific application to be registered on the table 221 on the basis of the use-frequency measured by the use-frequency measuring unit. In this instance, a high-use frequency application is automatically registered on the table 221.

In the first and second embodiments, the page table 151 includes the page table for ROM 153 and the page table for RAM 155, and the page table updating unit 159 switches the page table between the page table for ROM 153 and the page table for RAM 155. Alternatively, the page table 151 may be in a form in which the tables for ROM and for RAM are not separated from each other. In this form, if switching between the ROM-operation and the RAM-operation occurs, the page table 151 is rewritten.

For example, when the operation is to be switched from the ROM-operation to the RAM-operation, the page table updating unit 159 deletes the physical address of the ROM 103, that has been stored in the page table 151. Thereafter, although the MMU 107 refers to the page table 151 if the RAM-operation is performed, mapping data of the virtual address with the physical address of the RAM 105 is not stored in the page table 151, thus a page fault occurs. Therefore, the page fault processing unit 157 reads the program from the ROM 103 and write the read program to the RAM 105. The page table updating unit 159 stores the physical address of the RAM 105 into the page table 151

Although the present invention has been described in detail by reference to the specific embodiments, it is obvious to those skilled in the art that the present invention is susceptible to various alterations or modifications without departing the scope of spirit of the invention.

### INDUSTRIAL APPLICABILITY

An information processing apparatus according to the present invention is useful as an electronic application, etc. for executing a program by switching ROM-operation and RAM-operation to implement a desired function.

1. An information processing apparatus, comprising:
a ROM for storing a program therein;
a RAM for temporarily storing therein the program read from the ROM;
a program execution unit that is adapted to read the program from the ROM or the RAM and execute the read program;
a memory management unit that is adapted to translate a virtual address output by the program execution unit to a physical address of the ROM or the RAM before the program execution unit reads the program from the ROM or the RAM;
a page table storage unit for storing therein a page table which is referred to by the memory management unit, and in which mapping data of a virtual address with a physical address of at least either of the ROM and the RAM corresponding to the virtual address is stored;
a detection unit that is adapted to detect a change in clock speed of the program execution unit;
an operation switching unit that is adapted to instruct, when the detection unit detects the change in clock speed from a low speed to a high speed during a ROM-operation in which the program execution unit reads the program from the ROM, switching from the ROM-operation to a RAM-operation in which the program execution unit reads the program from the RAM; and
a page table updating unit that is adapted to update the page table which is referred to by the memory management unit, depending on the instruction of the operation switching unit.

2-7. (canceled)

8. An information processing apparatus, comprising:
a ROM for storing a program therein;
a RAM for temporarily storing therein the program read from the ROM;
a program execution unit that is adapted to read the program from the ROM or the RAM and execute the read program;
a memory management unit that is adapted to translate a virtual address output by the program execution unit to a physical address of the ROM or the RAM before the program execution unit reads the program from the ROM or the RAM; and
a page table storage unit for storing therein a page table which is referred to by the memory management unit, and in which mapping data of a virtual address with a physical address of at least either of the ROM and the RAM corresponding to the virtual address is stored,
a detection unit that is adapted to detect an operation to the information processing apparatus;
an operation switching unit that is adapted to instruct, when the detection unit detects the operation to the information processing apparatus during a ROM-operation in which the program execution unit reads the program from the ROM, switching from the ROM-operation to a RAM-operation in which the program execution unit reads the program from the RAM; and
a page table updating unit that is adapted to update the page table which is referred to by the memory management unit, depending on the instruction of the operation switching unit.

9. An information processing apparatus, comprising:
a ROM for storing a program therein;
a RAM for temporarily storing therein the program read from the ROM;
a program execution unit that is adapted to read the program from the ROM or the RAM and execute the read program;
a memory management unit that is adapted to translate a virtual address output by the program execution unit to a physical address of the ROM or the RAM before the program execution unit reads the program from the ROM or the RAM;
a page table storage unit for storing therein a page table which is referred to by the memory management unit, and in which mapping data of a virtual address with a physical address of at least either of the ROM and the RAM corresponding to the virtual address is stored;
a detection unit that is adapted to detect an occurrence of irregular interruption process other than regularly-occurred process in the information processing apparatus;
an operation switching unit that is adapted to instruct, when the detection unit detects the occurrence of the irregular interruption process during a ROM-operation in which the program execution unit reads the program from the ROM, switching from the ROM-operation to a RAM-operation in which the program execution unit reads the program from the RAM; and
a page table updating unit that is adapted to update the page table which is referred to by the memory management unit, depending on the instruction of the operation switching unit.
